(19) United States
(12) Patent Application Publication
(10) Pub. No.: US 2026/0322452 A1
(43) Pub. Date: Oct. 15, 2026

(54) BEAMFORMED TRANSMISSION OF CSI-RS

(71) Applicant: Telefonaktiebolaget LM Ericsson (publ), Stockholm (SE)

(72) Inventors: Anteneh Atumo GEBREMARIAM, Malmo (SE); Magnus HURD, Stockholm (SE); Zhiming YIN, Danderyd (SE); Hong ZHU, Lund (SE); Pär ANKEL, Nodinge (SE)

(21) Appl. No.: 19/481,994

(22) PCT Filed: May 24, 2023
(86) PCT No.: PCT/SE2023/050506

§ 371 Date: Nov. 6, 2025

(51) Int. Cl. H04B 7/06; H04L 5/00

(52) U.S. Cl. CPC H04B 7/0626; H04B 7/0617; H04L 5/0023

(57) ABSTRACT

There is provided techniques for concurrent transmission of CSI-RSs in different grids-of-beams. Each grid-of-beams is composed of a respective set of beams. A method is performed by a network node. The method comprises assigning CSI-RS resources to a time-frequency grid. The time-frequency grid is divided into frequency resources in frequency domain and into time resources in time domain. The CSI-RS resource for at least two of the different grids-of-beams are, for one and the same time resource, interleaved with each other over the frequency resources. The CSI-RS resource for different beams within each set of beams are, for one and the same frequency resource, interleaved with each other over the time resources. The method comprises performing a beamformed CSI-RS transmission in accordance with the assigned CSI-RS resources.

### TECHNICAL FIELD

Embodiments presented herein relate to a method, a network node, a computer program, and a computer program product for concurrent transmission of channel state information reference signals (CSI-RSs) in different grids-of-beams.

### BACKGROUND

In general terms, in fifth generation (5G) new radio (NR) millimeter wave (mmW) frequency telecommunication systems, maintaining decent coverage for user equipment (UEs) can be challenging unless there are beams directed towards the UEs. Beamforming enables a dynamic creation of directed beams, by changing phase and amplitude of individual antenna elements, towards a particular UE. One purpose of this is to enhance the link budget for the UEs. To account for the dynamic change of the radio channel conditions and UE mobility, it might be necessary to regularly measure and evaluate different beam directions and pick the one best serving the UE for communication with a network node.

FIG. 1 is a schematic diagram illustrating a communication network 100 where embodiments presented herein can be applied. The communication network 100 could be a third generation (3G) telecommunications network, a fourth generation (4G) telecommunications network, a fifth (5G) telecommunications network, a sixth (6G) telecommunications network, and support any 3rd Generation Partnership Project (3GPP) telecommunications standard. The communication network 100 comprises a transmission and reception point 140 configured to provide network access to user equipment 160 in an (radio) access network 110 in beams, as represented by beam 150. The access network 110 is operatively connected to a core network 120. The core network 120 is in turn operatively connected to a service network 130, such as the Internet. The user equipment 160 is thereby, via the transmission and reception point 140, enabled to access services of, and exchange data with, the service network 130. Operation of the transmission and reception point 140 is controlled by a network node 200. The network node 200 might be part of, collocated with, or integrated with the transmission and reception point 140. Examples of network nodes 200 are (radio) access network nodes, radio base stations, base transceiver stations, Node Bs (NBs), evolved Node Bs (eNBs), gNBs, access points, access nodes, and integrated access and backhaul nodes. Examples of user equipment 160 are wireless devices, mobile stations, mobile phones, handsets, wireless local loop phones, smartphones, laptop computers, tablet computers, network equipped sensors, network equipped vehicles, and so-called Internet of Things devices.

3GPP has in 3GPP TR 38.802 “Study on new radio access technology Physical layer aspects”, version 14.2.0, section 6.1.6, defined layer 1 and layer 2 beam management procedures. Procedure 1 (P1) represents an initial access procedure, Procedure 2 (P2) is used for beam refinement and tracking at the network node, and Procedure 3 (P3) is used for UE beam refinement.

The procedures P1, P2, and P3 are schematically illustrated in FIG. 2 and can be summarized as follows.

For the P1 procedure the network node, via its TRP 140, broadcasts Synchronization Signal Blocks (SSBs) in the downlink in a set of wide beams 150a such that the UE 160, using a beam 170a for reception of the SSBs, is able to measure and send a random-access preamble for the beam corresponding to the strongest SSB. SSBs are transmitted over a set of wide beams 150 to cover several UEs 160 at the same time. After the initial access is completed, the network node 200 triggers a P2 procedure to identify the best narrow beam within the strongest wide beam that was identified during the P1 procedure. Typically, the P2 procedure involves the network node to, via its TRP 140, transmit CSI-RSs in the downlink in a set of narrow beams 150b such that the UE 160, using a beam 170b for reception of the CSI-RSs, is able to measure and report (such as in a CSI report) at least the narrow beam for which the reference signal received power (RSRP) was highest. In case the UE 160 is capable of beamforming, a P3 procedure can then follow where the network, via its TRP 140, transmits CSI-RSs in the downlink in the beam 150c identified in the P2 procedure as the best for serving the UE 160 such that the UE 160, using a set of beams 170c for reception of the CSI-RSs, is able to identify which of the narrow beams is the best for subsequent communication with the network node.

After the completion of the P2 procedure (possibly followed by the optional P3 procedure), data transmission and reception is at the network node performed on narrow beams, as determined during the P2 procedure. However, to account for the dynamic changes in the radio channel and mobility of UEs, the network node needs to track each UE by transmitting further CSI-RSs (per candidate narrow beams) towards each UE and process the response from UEs to determine the best new narrow beam direction.

Time-domain beamforming might be used to build affordable beamforming systems for high-band deployments. This means that beamforming weights are applied per antenna element at the TRP after the point of Inverse Fast Fourier Transform (IFFT) as seen from the downlink perspective. To have even more cost-efficient deployments only a few beam directions may be allowed, to reduce the amount of data the beamforming machinery needs to manage.

The P2 procedure, based on aperiodic CSI-RS transmissions for refinement and tracking, typically requires a CSI-RS transmission per candidate narrow beam and UE. Ideally, the candidate beams selected by the network node should cover (and exhaust) the region within the wide beam area of the UE. The CSI-RS transmissions may then consume several downlink slots even for a single request for a CSI report. A corresponding uplink CSI-report (per UE) is also required, requiring resources in one slot. Moreover, a control channel, such as a physical downlink control channel (PDCCH) is needed to schedule each CSI report on a data channel, such as a physical uplink shared cannel (PUSCH), requiring at least one symbol of the downlink resources, thus resulting in overhead signaling. This overhead signaling scales proportional to the number of UEs served by the network node. As a result, downlink throughput as well as the overall system performance, is reduced.

On the other hand, sharing CSI-RSs among all UEs served by the network node requires providing CSI-RSs for each Transmission Configuration Indicator (TCI) state. For systems where only a few concurrent downlink beams are allowed, the time resources may be limited. For instance, it sets a limit to UEs using connected mode discontinuous reception (C-DRX) with regards to the on-duration time (i.e., the DRX “on time”). The sharing and the aspect of mobility (from one TCI state to another) requires beam tracking to offer CSI-RS of all TCI states in all narrow beams during the on-duration to be measured.

Hence, there is still a need for improved transmission of CSI-RSs.

### SUMMARY

An object of embodiments herein is to provide transmission of CSI-RSs that does not suffer from the above issues, or at least where the above issues are mitigated or reduced.

A particular object is to provide transmission of CSI-RSs where the overhead signaling does not depend on the number of UEs served by the network node.

A particular object is to enable concurrent transmission of CSI-RSS for many ues.

According to a first aspect there is presented a method for concurrent transmission of CSI-RSs in different grids-of-beams. Each grid-of-beams is composed of a respective set of beams. The method is performed by a network node. The method comprises assigning CSI-RS resources to a time-frequency grid. The time-frequency grid is divided into frequency resources in frequency domain and into time resources in time domain. The CSI-RS resource for at least two of the different grids-of-beams are, for one and the same time resource, interleaved with each other over the frequency resources. The CSI-RS resource for different beams within each set of beams are, for one and the same frequency resource, interleaved with each other over the time resources. The method comprises performing a beamformed CSI-RS transmission in accordance with the assigned CSI-RS resources.

According to a second aspect there is presented a network node for concurrent transmission of CSI-RSs in different grids-of-beams. Each grid-of-beams is composed of a respective set of beams. The network node comprises processing circuitry. The processing circuitry is configured to cause the network node to assign CSI-RS resources to a time-frequency grid. The time-frequency grid is divided into frequency resources in frequency domain and into time resources in time domain. The CSI-RS resource for at least two of the different grids-of-beams are, for one and the same time resource, interleaved with each other over the frequency resources. The CSI-RS resource for different beams within each set of beams are, for one and the same frequency resource, interleaved with each other over the time resources. The processing circuitry is configured to cause the network node to perform a beamformed CSI-RS transmission in accordance with the assigned CSI-RS resources. According to a third aspect there is presented a network node for concurrent transmission of CSI-RSs in different grids-of-beams. Each grid-of-beams is composed of a respective set of beams. The network node comprises an assign module configured to assign CSI-RS resources to a time-frequency grid. The time-frequency grid is divided into frequency resources in frequency domain and into time resources in time domain. The CSI-RS resource for at least two of the different grids-of-beams are, for one and the same time resource, interleaved with each other over the frequency resources. The CSI-RS resource for different beams within each set of beams are, for one and the same frequency resource, interleaved with each other over the time resources. The network node comprises a transmit module configured to perform a beamformed CSI-RS transmission in accordance with the assigned CSI-RS resources.

According to a fourth aspect there is presented a computer program for concurrent transmission of CSI-RSs in different grids-of-beams. Each grid-of-beams is composed of a respective set of beams. The computer program comprises computer code which, when run on processing circuitry of a network node, causes the network node to perform actions. One action comprises the network node to assign CSI-RS resources to a time-frequency grid. The time-frequency grid is divided into frequency resources in frequency domain and into time resources in time domain. The CSI-RS resource for at least two of the different grids-of-beams are, for one and the same time resource, interleaved with each other over the frequency resources. The CSI-RS resource for different beams within each set of beams are, for one and the same frequency resource, interleaved with each other over the time resources. One action comprises the network node to perform a beamformed CSI-RS transmission in accordance with the assigned CSI-RS resources.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects provide transmission of CSI-RSS that does not suffer from the above issues.

Advantageously, these aspects provide transmission of CSI-RSs where the overhead signaling does not depend on the number of UEs served by the network node.

Advantageously, these aspects enable concurrent transmission of CSI-RSs for many UEs

Advantageously, these aspects enable more UEs to be served per network node since beam management measurement are available for more UEs.

Advantageously, these aspects improve the latency for beam management since the CSI-RS resources can be configured (or confined) only in a few slots but still be used to serve several UEs compared to legacy with dedicated CSI-RSs per narrow beam per UE.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communications network according to embodiments;

FIG. 2 schematically illustrates beam management procedures according to an embodiment;

FIG. 3 schematically illustrates wide beams and narrow beams according to an embodiment;

FIG. 4 schematically illustrates a time-frequency grid according to an embodiment;

FIG. 5 is a flowchart of methods according to embodiments;

FIGS. 6 and 7 schematically illustrate time-frequency grids according to embodiments;

FIG. 8 is a signaling diagram of methods according to an embodiment;

FIG. 9 is a schematic diagram showing functional units of a network node according to an embodiment;

FIG. 10 is a schematic diagram showing functional modules of a network node according to an embodiment; and

FIG. 11 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

As noted above, there is still a need for improved transmission of CSI-RSS.

According to at least some of the herein disclosed embodiments, shared CSI-RSs are used to represent narrow beams. Since there needs to be many variants of the CSI-RSs in high-band (for example one per TCI state), a TCI-dependent mapping of the CSI-RS resources onto frequency resources is used in some embodiments. Many CSI-RS variants (for example one per TCI state) can be provided in concurrently transmitted narrow beams (with one narrow beam covered by each SSB beam), assuming there is a high enough number of beam directions to support these concurrent CSI-RS transmissions. For example, there might be one narrow beam direction per CSI-RS variant. This enables sharing of CSI-RS also for high-band, where typically different UEs are in several different TCI states, at beam management without an increased need for time domain resources.

In order to reduce the amount of downlink overhead, a shared CSI-RS resource allocation for the UEs within the same wide beam (or TCI state) can thus be used. This approach is similar to how SSBs are monitored by UEs and hence does not require any modification of UE behavior or UE implementation.

FIG. 3 illustrates an example with four wide beams 150a in which SSBs (SSB1, SSB2, SSB3, SSB4) are transmitted to cover a service area. Each wide beam 150a covers its own set of eight narrow beams 150b (denoted NB1 to NB 32). As illustrated in FIG. 3, for high-band there are typically wide beams 150a in which SSBs are transmitted.

Each such wide beam, or SSB, is associated with a TCI state, with one unique TCI state per SSB. As a result, for all UEs to share CSI-RS, all narrow beams 150b for each and every TCI state (i.e., within each SSB) need to be accounted for. In other words, there needs to be a CSI-RS resource for each narrow beam 150b within the coverage of each wide beam 150a.

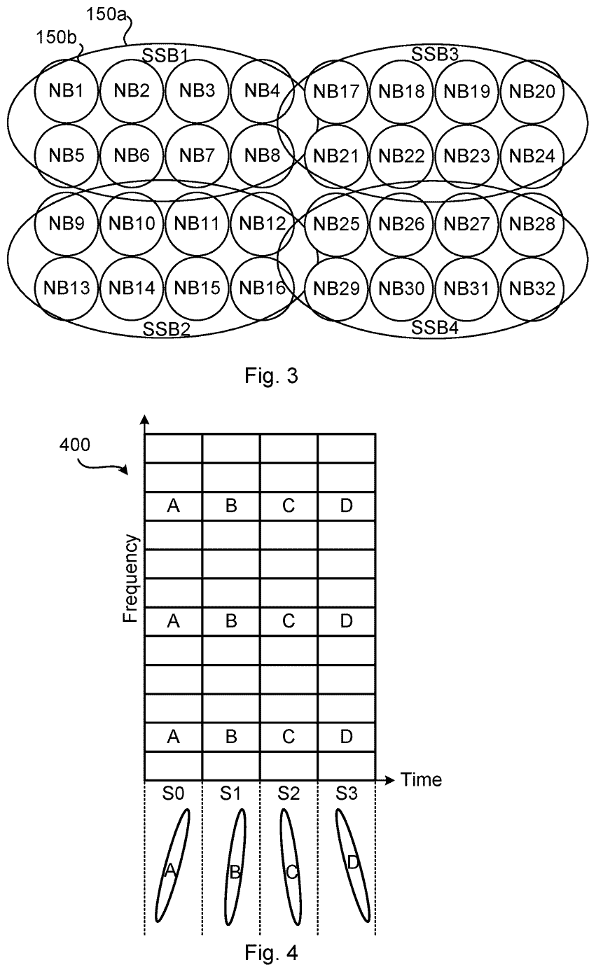

In FIG. 4 is illustrated a traditional approach for transmission of CSI-RSs in narrow beams. In particular, in FIG. 4 is shown an example of CSI-RS resource mapping for beam refinement and tracking for one single TCI state according to the “row 1”—configuration specified in 3GPP TS 38.211 “NR; Physical channels and modulation”, version 17.4.0. It is illustrated how the CSI-RS resources are scheduled in a time-frequency grid (i.e., in the time-frequency domain) 400 to the UEs for one single TCI state (i.e., for one SSB, or one wide beam). One CSI-RS resource (represented by (many) subcarriers-in this figure represented by 3 subcarriers in one physical resource block, PRB) is transmitted in each symbol and represents one narrow beam for the UEs to measure on. That is, in symbol So the CSI-RS resource denoted “A” is transmitted in a first narrow beam, in symbol S1 the CSI-RS resource denoted “B” is transmitted in a second narrow beam, in symbol S2 the CSI-RS resource denoted “C” is transmitted in a third narrow beam, and in symbol S3 the CSI-RS resource denoted “D” is transmitted in a fourth narrow beam. Since there are four narrow beams, four symbols are needed in the time domain for the CSI-RS to be transmitted in each narrow beam. After the UEs have measured on the CSI-RS as transmitted in all the narrow beams, the UEs report certain details of the measurements, for instance which narrow beam is the strongest one (i.e., the beam for which the RSRP was the highest). This information can then be used by the network node for efficient scheduling of the UEs. The CSI-RS resources shown in FIG. 4 as used for beam management are one-port signals (see, row 1 in table 7.4.1.5.3-1 of aforementioned 3GPP TS 38.211). As illustrated in FIG. 4, the one-port CSI-RS is transmitted on every fourth subcarrier, with a subcarrier offset indicated by the parameter frequency DomainAllocation as defined in aforementioned 3GPP TS 38.211.

As will be further disclosed below, to counteract the need for time domain resources to represent all TCI states, the CSI-RS resources can be multiplexed in frequency domain for different TCI states (one per SSB).

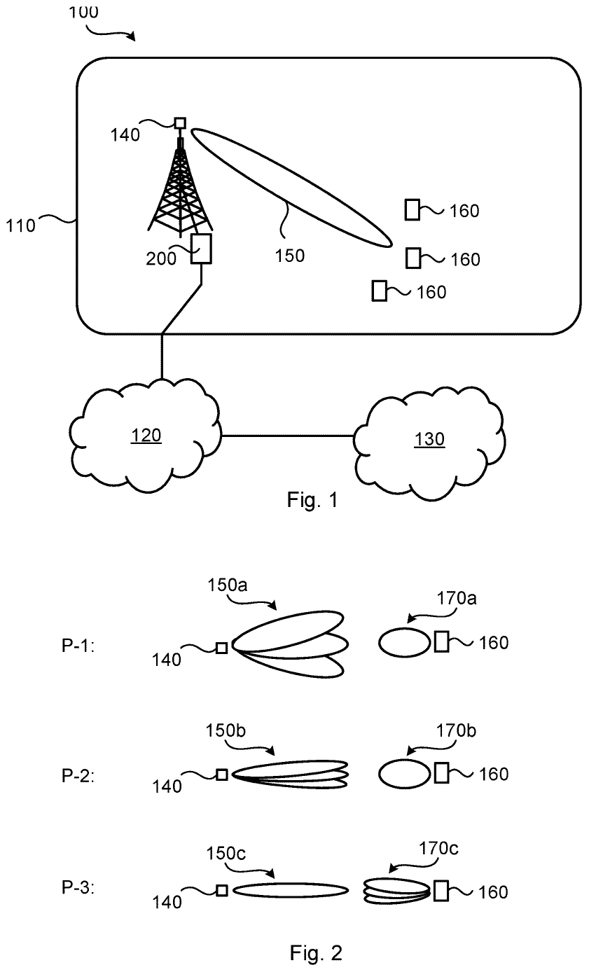

The embodiments disclosed herein in particular relate to techniques for concurrent transmission of CSI-RSs in different grids-of-beams. In this respect, with reference again to FIG. 2 and FIG. 3, beams 150b (which are all covered by one of the beams 150a) can be regarded as one grid-of-beam. That is, with particular reference to FIG. 3, the narrow beams denoted NB1-NB8, as covered by a wide beam in which SSB1 is transmitted, can be regarded as belonging to a first grid-of-beams, whereas narrow beams NB9-NB16, as covered by a wide beam in which SSB2 is transmitted, can be regarded as belonging to a second grid-of-beams, and so on. In order to obtain techniques for concurrent transmission of CSI-RSs in different grids-of-beams there is provided a network node 200, a method performed by the network node 200, a computer program product comprising code, for example in the form of a computer program, that when run on a network node 200, causes the network node 200 to perform the method.

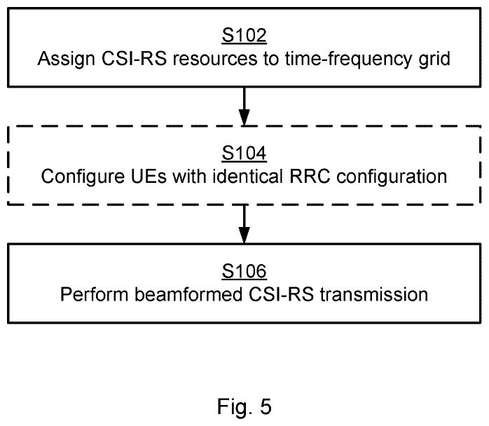

FIG. 5 is a flowchart illustrating embodiments of methods for concurrent transmission of CSI-RSs in different grids-of-beams. Each grid-of-beams is composed of a respective set of beams. The methods are performed by the network node 200. The methods are advantageously provided as computer programs 1120.

In general terms, the method is based on that per symbol, the CSI-RSs in (possibly) all subcarriers are concurrently transmitted in a respective beam in each of the different sets of beams, where each set of beams belong to a respective grid-of-beams.

S102: The network node 200 assigns CSI-RS resources to a time-frequency grid 600a, 600b, 700.

The time-frequency grid 600a, 600b, 700 is divided into frequency resources in frequency domain and into time resources in time domain.

The CSI-RS resource for at least two of the different grids-of-beams are, for one and the same time resource, interleaved with each other over the frequency resources.

The CSI-RS resource for different beams within each set of beams are, for one and the same frequency resource, interleaved with each other over the time resources.

S106: The network node 200 performs a beamformed CSI-RS transmission in accordance with the assigned CSI-RS resources. In some examples, the CSI-RS are transmitted using millimeter wave (mmW) communication.

Embodiments relating to further details of concurrent transmission of CSI-RSs in different grids-of-beams as performed by the network node 200 will now be disclosed with continued reference to FIG. 5.

As disclosed above, CSI-RS can be transmitted as part of a beam management procedure. Therefore, in some embodiments, the beamformed CSI-RS transmission is performed as part of a beam management process for UEs 160 served in the sets-of-beams. The beam management process might be either a P2 procedure or a P3 procedure.

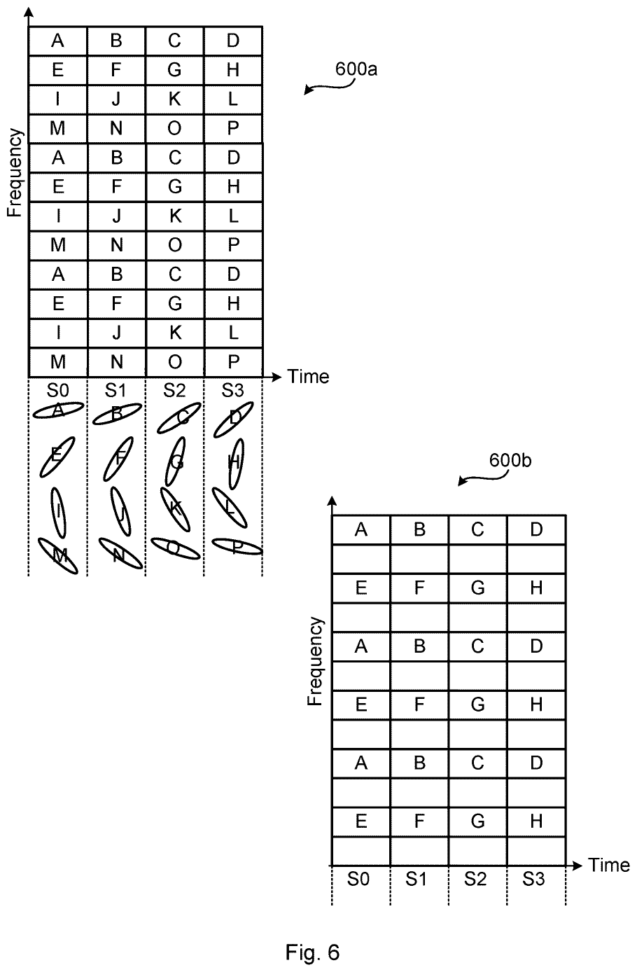

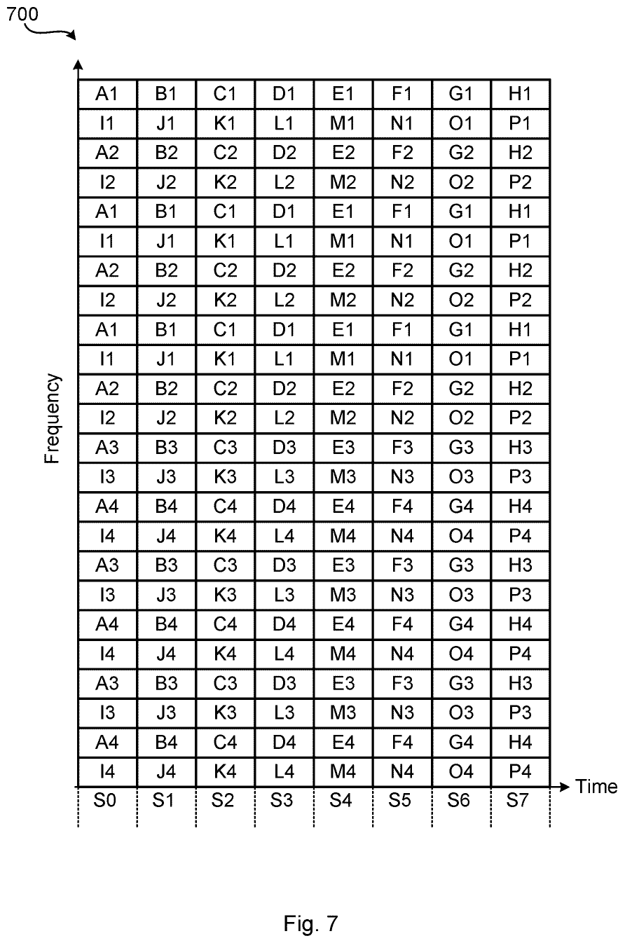

In some aspects, the CSI-RS are divided in frequency by different bandwidth locations being allocated to different CSI-RSs. Hence, in some embodiments, all the CSI-RS resource assigned to a respective set of the different grids-of-beams are contained within a corresponding respective set of frequency resources, where there are at least two different such respective sets of the different grids-of-beams and corresponding respective sets of frequency resources. The frequency resource might be adjacent frequency resources, as in the time-frequency grids 600a and 700 or non-adjacent as in the time-frequency grid 600b, see examples in FIGS. 6 and 7 as will be further described below. In some examples, the minimum unit of bandwidth for one set of frequency resources is one PRB. That is, in some embodiment, each set of (adjacent) frequency resources extends in frequency by a multiple of one PRB.

In some aspects, the CSI-RS are divided in time by different symbols being allocated to different CSI-RSs. That is, in some embodiments, all the CSI-RS resource assigned to a respective set of the different beams within each set of beams are contained within a corresponding respective set of time resources, where there are at least two different such respective sets of the different beams within each set of beams and corresponding respective sets of time resources. In some examples, the time resources are adjacent time resources and the minimum unit of time for one set of adjacent time resources is one PRB. That is, in some embodiments, each set of adjacent time resources extends in time by a multiple of one PRB.

In some embodiments, each of the grids-of-beams belongs to a respective unique TCI state. In some embodiments, each respective unique TCI state is associated with an SSB. In some examples there are as many concurrent beam directions as TCI states. That is, in some embodiments, the CSI-RS is concurrently transmitted in at least as many beams as there are TCI states in a service area covered by digital beamforming.

In some aspects, the frequency resources are subcarriers such that one CSI-RS is transmitted per subcarrier. That is, in some embodiments, each frequency resource corresponds to one subcarrier.

In some aspects, the time resources are symbols and the CSI-RSs of a grid-of-beams are spread on symbols, for example on subsequent symbols. That is, in some embodiments, each time resource has a time duration of one symbol. The symbol might be an orthogonal frequency-division multiplexing (OFDM) symbol.

In some aspects the CSI-RSs are, per symbol, transmitted in as many beams as there are grid-of-beams. Hence, in some embodiments, in each symbol, CSI-RSs are transmitted in at least as many beams as there are grid-of-beams.

Intermediate reference is here made to FIG. 6 in which is illustrated two examples of time-frequency grids 600a, 600b for CSI-RS resource mapping in the frequency time domain for beam refinement and tracking, where up to 4 CSI-RS resources (one per TCI state) can be multiplexed in the frequency domain to reduce the need for time domain resources. Hence, per each symbol in the time domain there can be four concurrently transmitted narrow beams, one covered by each SSB. In FIG. 6 is also shown the CSI-RS resource mapping corresponding to different TCI states, still using a “row 1”—configuration. In the time-frequency grid 600a all frequency resources are adjacent set of frequency resources. In the time-frequency grid 600b the frequency resources belong to non-adjacent set of frequency resources. Further, the time-frequency grid 600a is an example where there are 16 CSI-RS resources in total, denoted “A” to “P”. In symbol So the CSI-RS resource denoted “A” is transmitted in a first narrow beam, the CSI-RS resource denoted “E” is transmitted in a second narrow beam, the CSI-RS resource denoted “I” is transmitted in a third narrow beam, and the CSI-RS resource denoted “M” is transmitted in a fourth narrow beam. In symbol S1 the CSI-RS resources denoted “B”, “F”, “J”, and “N” are transmitted in four other narrow beams, and so on. The time-frequency grid 600b is an example where there are eight CSI-RS resources in total, denoted “A” to “H”. In symbol So the CSI-RS resource denoted “A” is transmitted in a first narrow beam, and the CSI-RS resource denoted “E” is transmitted in a second narrow beam. In symbol Si the CSI-RS resources denoted “B” and “F” are transmitted in two other narrow beams, and so on.

Each symbol can be configured to transmit CSI-RS for four different TCI states (one TCI state for each value of the subcarrier offset indicated by the parameter frequencyDomainAllocation). This assumes a beamforming capacity that can create as many concurrent beam directions as TCI states. Many concurrent beam directions are needed since narrow beams of one TCI state is in general different than narrow beams of another TCI state. For pure analog beamforming multiplexing like this is not possible. This example shows that the herein disclosed embodiments enable a TCI-dependent mapping of the CSI-RS resources onto frequency resources (above represented by different frequency offsets) together with a number of beam directions enough to support concurrent CSI-RS transmissions (for different TCI states). In turn, this enables sharing of CSI-RSs also for high-band (where typically several TCI states are present) without an increased need for time domain resources. This sharing of CSI-RS resources is transparent to the UEs. The UEs are configured as if having dedicated CSI-RS resources. From UE perspective there is no difference whether the CSI-RS resources are also used by other UEs.

The example in FIG. 6 is in contrast to traditional approaches for high-band, according to which the CSI-RS resources would be scheduled for individual UEs on user-dedicated (different) resources (for instance, in different slots). This implies that the resources for CSI-RS transmissions scales with the number of UEs times the number of narrow beams. In FIG. 6 the UEs instead share resources such that a transmitted CSI-RS (in a specific narrow beam) on these shared resources can be measured by all UEs (subject to the same TCI state). Therefore, the resources used for CSI-RS transmissions in this case instead scales only with the number of TCI states.

Depending on the number of narrow beams per wide beam and the CSI-RS processing capacity of a UE, the CSI-RS resources (one per narrow beam) may be mapped to several DL slots (number of used symbols stays the same). In the illustrative example of FIG. 6, the assumption is that four narrow beams are configured per wide beam and that the UEs are capable of processing the CSI transmissions for all four narrow beams within one slot. Each narrow beam is represented by a CSI-RS resource; each CSI-RS is transmitted on one symbol. As a result, four symbols in the time domain are needed to represent all the narrow beams in the example of FIG. 6.

In some aspects, to make the UEs 160 aware of the beamformed CSI-RS transmission, all UEs 160 (that are sharing CSI-RSs) are configured with identical RRC configuration regarding the CSI-RS resources. In particular, in some embodiments, the network node 200 is configured to perform (optional) step S104.

S104: The network node 200 configures all UEs 160 served by the network node and for which the CSI-RSs are shared with identical RRC configuration regarding the CSI-RS resources.

Different examples of how the UEs 160 might be configured with the RRC configuration regarding the CSI-RS resources will be disclosed next.

In some embodiments, the UEs 160 are a-periodically configured for the beamformed CSI-RS transmission, and the beamformed CSI-RS transmission is indicated using a specific trigger state in a downlink control information (DCI) CSI request field. In further detail, in this way, all UEs sharing the CSI-RS resources are made aware of the one-shot CSI-RS transmission using the specific trigger state in the CSI request field. Associated to the trigger state can also be an aperiodic CSI report (where measurements related to the CSI-RSs can be reported from the UEs 160 to the network node 200).

In some embodiments, the UEs 160 are semi-persistently configured for the beamformed CSI-RS transmission, and the beamformed CSI-RS transmission is indicated in a medium access control (MAC) control element (CE). In further detail, the transmission of this type of CSI-RSs can be scheduled by a MAC CE indicating which CSI-RS resources that shall be activated together with TCI states applicable for the constituent CSI-RS resources, in similar fashion as specified in 3GPP TS 38.321 “NR; Medium Access Control (MAC) protocol specification”, section 6.1.3.12, version 17.4.0. Details of the semi-persistent CSI-RS transmission might be defined at RRC configuration. A specific trigger state provided in the CSI request field of the UL DCI might be used to request an aperiodic or semi-persistent CSI report based on the semi-persistent CSI-RS.

In some embodiments, the UEs 160 are configured for periodic beamformed CSI-RS transmission. In further detail, in this case the beamformed CSI-RS transmission might be periodically performed. Periodic CSI reports (not explicitly triggered) can also be configured, or specific trigger states can be defined and provided in the CSI request field of the UL DCI to request an aperiodic or semi-persistent CSI report based on the periodic CSI-RS.

In case of mobility, movement of a given UE might cause the given UE from being in one TCI state to being in another TCI state. With aperiodic CSI reporting the network node 200 will be able to indicate to the given UE what CSI-RS (with a certain TCI, or in this context, certain frequency resources) the CSI report shall be based on (as represented by a trigger state). This information can be explicitly provided for each CSI reporting occasion, using a trigger state in the CSI Request field of the UL DCI (on PDCCH). For semi-persistent CSI reporting (based on semi-persistent or periodic CSI-RS transmission), a specific trigger state in the CSI Request field of the UL DCI initiates periodic CSI reporting that will continue until another UL DCI with the same trigger state is issued, as described in 3GPP TS 38.214 “NR; Physical layer procedures for data”, version 17.5.0, end of Section 5.2.1.5.2, Tables 5.2.1.5.2-1 and 5.2.1.5.2-2.

An approach for mobility could then be to deactivate CSI reporting for the source TCI state (using one UL DCI) and activate CSI reporting on the target TCI state (using another UL DCI). This would avoid having CSI reports for all TCI states ongoing all the time; CSI reports for TCI states outside the current location of the UE may not be useful. This selective use of CSI reporting would not be possible for periodic CSI reports without RRC reconfiguration.

A mixed approach is also possible where some frequency resources for CSI-RS are used for shared narrow beams (according to certain TCI states), as explained above, whereas others are used for user-specific selection of narrow beams (according to certain TCI states). A potential PDCCH bottleneck can be removed if semipersistent CSI-RS and CSI reporting is introduced. A potential PUSCH bottleneck can be mitigated by multiplexing the CSI reports in frequency (using frequency-division multiplexing, FDM), in time (using time-division multiplexing TDM, so-called minislots) or possibly in spatial domain (using space-division multiplexing, SDM).

The TRP 140 might be equipped with a frontend (as part of hybrid beamforming) introducing analog beamforming. This would introduce several (broad) beam directions that cannot occur concurrently. These analog beam directions would together cover a service area and each of them could cover a set of TCI states. Essentially, this means that the above-described procedure of how to transmit CSI-RS for narrow beams per TCI would be repeated per analog beam, but at a different time.

If there are N wide beams (or, equivalently, SSBs) to cover the service area of the network node, then there needs to be N different versions of the narrow beams (each represented by a CSI-RS resource, as shown in FIG. 6). In other words, for any number of UEs served by the network node, only N instances of such CSI-RS resources are required. However, for traditional approaches, the number of CSI-RS resource instances scales up with the number of UEs, irrespective of the number of SSBs.

As will be disclosed next, it is possible to have more than four TCI states per symbol.

According to a first example, the CSI-RS resources can be divided in frequency by allocating different pieces of the bandwidth to different CSI-RS resources. An examples of this is illustrated in FIG. 7. In FIG. 7 is illustrated an example of a time-frequency grid 700 where the bandwidth of the carrier is divided in two parts, thereby doubling the number of TCI states per symbol. In FIG. 7 is illustrated a CSI-RS resource mapping (for a “row 1”-configuration, as in table 7.4.1.5.3-1 of aforementioned 3GPP TS 38.211) with 8 TCI states per symbol (S0 to S7) and total of 16 TCI states over 2 time periods with 4 symbols in each time period (i.e., symbols So to S3 in the first time period and symbols S4 to S7 in a second time period). This example would thus accommodate for up to 16 SSBs. The CSI-RS resources are denoted “A1” to “P4”. CSI-RS resources “A1” to “P2” span the upper half of the bandwidth whereas CSI-RS resources “A3” to “P4” span the lower half of the bandwidth. In symbol So the CSI-RS resource denoted “A1” is transmitted in a first narrow beam, the CSI-RS resource denoted “I1” is transmitted in a second narrow beam, the CSI-RS resource denoted “A2” is transmitted in a third narrow beam, the CSI-RS resource denoted “I2” is transmitted in a fourth narrow beam, the CSI-RS resource denoted “A3” is transmitted in a fifth narrow beam, the CSI-RS resource denoted “I3” is transmitted in a sixth narrow beam, the CSI-RS resource denoted “A4” is transmitted in a seventh narrow beam, and the CSI-RS resource denoted “I4” is transmitted in an eight narrow beam, and so on.

The different bandwidths for the different CSI-RS resource could be specified when configuring the CSI-RS resources using the RRC parameter freqBand as in 3GPP TS 38.331 “NR; Radio Resource Control (RRC); Protocol specification” version 17.4.0 that represents both number of PRBs and the starting PRB for the resource.

According to a second example, a “row 2”—configuration as in table 7.4.1.5.3-1 of aforementioned 3GPP TS 38.211 is used. Assigning Density=1 implies that the CSI-RS resources are transmitted every 12th RE in each PRB; assigning Density=0.5 implies that the CSI-RS resources are transmitted every 12th RE of each second PRB.

It is noted that when there are not any UEs that need a beamforming management measurement for a certain TCI state, then no CSI-RS needs to be transmitted. Instead, those REs can be used for other downlink transmissions. With reference to the example illustrated in FIG. 7, if there is only one UE in TCI 1, then it is sufficient to transmit CSI-RS in ⅛ of the REs in the first 4 symbols occasion, and no CSI-RS in the second 4 symbols occasion.

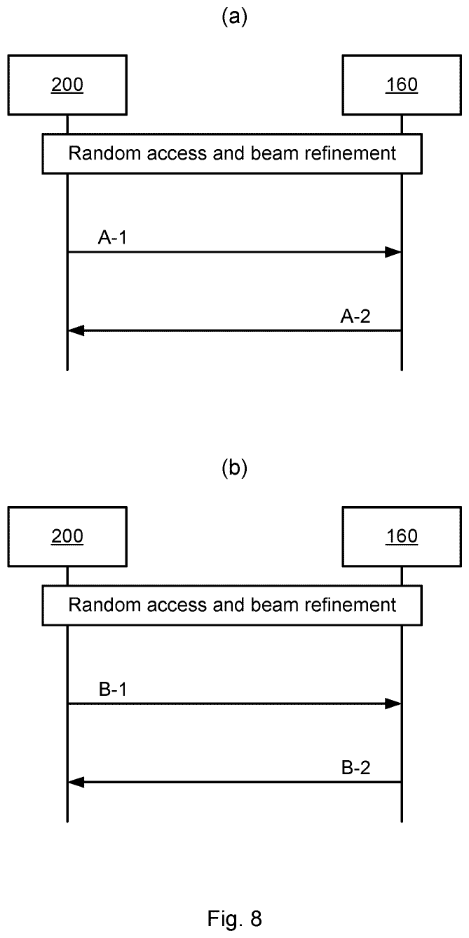

A further comparison between the herein disclosed embodiments and traditional approaches for beamformed transmission of CSI-RS will be made next with reference to the signalling diagrams illustrated in FIG. 8. In FIG. 8(a) is provided a signaling diagram for a legacy approach and in FIG. 8(b) is provided a signaling diagram in accordance with herein disclosed embodiments. It is noted that the signaling diagrams illustrates high-level procedures. For illustrative purposes, an example scenario will be used with 12 SSBs per network node, with four narrow beams per SSB (corresponding to four CSI-RS symbols per SSB), with 100 connected UEs per network node, with an SSB periodicity of 20 ms (corresponding to 160 slots for numerology 3), with 30% data active UEs (also referred as the activity factor), with a beam tracking periodicity for data active UEs of 40 ms, and with beam tracking periodicity for data inactive UEs of 80 ms. In each of FIG. 8(a) and FIG. 8(b), a random access procedure and a beam refinement procedure are first performed between the network node 200 and the UE 160.

The legacy approach in FIG. 8(a) will be disclosed next.

Action A-1: aperiodic CSI-RS resources are scheduled in downlink for each UE in the system, for both data active and data inactive UEs. For data active UEs, each UE will be allocated CSI-RS resources corresponding to four narrow beams (in one CSI-RS occasion) every 40 ms whereas inactive UEs will be allocated CSI-RS resources every 80 ms. For 30% data active UEs in the system, 30 CSI-RS occasions for data active UEs every 40 ms and 70 CSI-RS occasions for data inactive UEs are required. Thus, over 80 ms, 2. 30 CSI-RS occasions for active UEs and 1·70 CSI-RS occasions are required. When converted to a time-domain resource: 2·30·4+1·70·4=520 symbols are required.

Action A-2: aperiodic CSI-reports are scheduled in uplink for each connected UE in the system. For active UEs, 2·30 uplink slots are required for data active UE over 80 ms where a CSI report may as be multiplexed with uplink data transmission. In the case of inactive UEs, 1·70 uplink slots are required. In total over 80 ms, 2·30+1·70=130 uplink slots are required.

The beamformed transmission of CSI-RS in accordance with herein disclosed embodiments in FIG. 8(b) will be disclosed next.

Action B-1: 12 aperiodic CSI-RS resources corresponding to 12 SSBs are required for all UEs, both active and inactive. For both active and inactive UEs, one CSI-RS resource per SSB per 40 ms is scheduled in downlink, i.e., 12·4=48 symbols. Thus, over 80 ms, only 2·12·4=96 symbols are required.

Action B-2: similar to action A-2, with respect to aperiodic CSI-reports for active UEs over 80 ms, 2·30 UL slots are required and for inactive UEs over 80 ms, 1·70 uplink slots are required. Thus, in total 2·30+1·70=130 uplink slots are required.

However if instead semi-persistent or periodic CSI reporting is configured, the cost of PDCCH for uplink grants can be avoided. However, for CSI reporting 130 uplink slots are still required over 80 ms. Another alternative of reducing the time-domain resource requirement is using FDM, if supported.

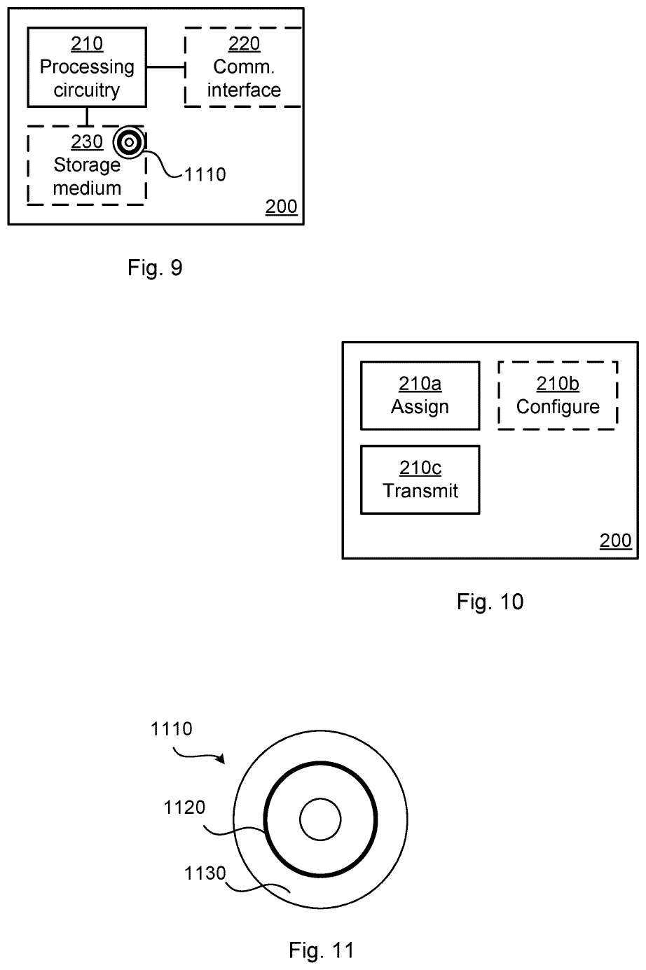

FIG. 9 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1110 (as in FIG. 11), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200 to perform a set of operations, or steps, as disclosed above. For example, the storage medium 230 may store the set of operations, and the processing circuitry 210 may be configured to retrieve the set of operations from the storage medium 230 to cause the network node 200 to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The network node 200 may further comprise a communications (comm.) interface 220 at least configured for communications with other entities, functions, nodes, and devices. As such the communications interface 220 may comprise one or more transmitters and receivers, comprising analogue and digital components. The processing circuitry 210 controls the general operation of the network node 200 e.g. by sending data and control signals to the communications interface 220 and the storage medium 230, by receiving data and reports from the communications interface 220, and by retrieving data and instructions from the storage medium 230. Other components, as well as the related functionality, of the network node 200 are omitted in order not to obscure the concepts presented herein.

FIG. 10 schematically illustrates, in terms of a number of functional modules, the components of a network node 200 according to an embodiment. The network node 200 of FIG. 10 comprises a number of functional modules; an assign module 210a configured to perform step S102, and a transmit module 210c configured to perform step S106. The network node 200 of FIG. 10 may further comprise a number of optional functional modules, such as a configure module 210b configured to perform step S104. In general terms, each functional module 210a: 210c may in one embodiment be implemented only in hardware and in another embodiment with the help of software, i.e., the latter embodiment having computer program instructions stored on the storage medium 230 which when run on the processing circuitry makes the network node 200 perform the corresponding steps mentioned above in conjunction with FIG. 10. It should also be mentioned that even though the modules correspond to parts of a computer program, they do not need to be separate modules therein, but the way in which they are implemented in software is dependent on the programming language used. Preferably, one or more or all functional modules 210a: 210c may be implemented by the processing circuitry 210, possibly in cooperation with the communications interface 220 and/or the storage medium 230. The processing circuitry 210 may thus be configured to from the storage medium 230 fetch instructions as provided by a functional module 210a: 210c and to execute these instructions, thereby performing any steps as disclosed herein.

The network node 200 may be provided as a standalone device or as a part of at least one further device. For example, the network node 200 may be provided in a node of the radio access network or in a node of the core network. Alternatively, functionality of the network node 200 may be distributed between at least two devices, or nodes.

These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the network node 200 may be executed in a first device, and a second portion of the of the instructions performed by the network node 200 may be executed in a second device; the herein disclosed embodiments are not limited to any particular number of devices on which the instructions performed by the network node 200 may be executed. Hence, the methods according to the herein disclosed embodiments are suitable to be performed by a network node 200 residing in a cloud computational environment. Therefore, although a single processing circuitry 210 is illustrated in FIG. 9 the processing circuitry 210 may be distributed among a plurality of devices, or nodes. The same applies to the functional modules 210a: 210c of FIG. 10 and the computer program 1120 of FIG. 11.

Some (radio) access network architectures define network nodes (or gNBs) comprising multiple component parts or nodes: a central unit (CU), one or more distributed units (DUs), and one or more radio units (RUs). The protocol layer stack of the network node 200 is divided between the CU, the DUs and the RUs, with one or more lower layers of the stack implemented in the RUs, and one or more higher layers of the stack implemented in the CU and/or DUs. The CU is coupled to the DUs via a fronthaul higher layer split (HLS) network; the CU/DUs are connected to the RUs via a fronthaul lower-layer split (LLS) network. The DU may be combined with the CU in some embodiments, where a combined DU/CU may be referred to as a CU or simply a baseband unit. A communication link for communication of user data messages or packets between the RU and the baseband unit, CU, or DU is referred to as a fronthaul network or interface. Messages or packets may be transmitted from the network node 200 in the downlink (i.e., from the CU to the RU) or received by the network node 200 in the uplink (i.e., from the RU to the CU).

FIG. 11 shows one example of a computer program product 1110 comprising computer readable storage medium 1130. On this computer readable storage medium 1130, a computer program 1120 can be stored, which computer program 1120 can cause the processing circuitry 210 and thereto operatively coupled entities and devices, such as the communications interface 220 and the storage medium 230, to execute methods according to embodiments described herein. The computer program 1120 and/or computer program product 1110 may thus provide means for performing any steps as herein disclosed.

In the example of FIG. 11, the computer program product 1110 is illustrated as an optical disc, such as a CD (compact disc) or a DVD (digital versatile disc) or a Blu-Ray disc. The computer program product 1110 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1120 is here schematically shown as a track on the depicted optical disk, the computer program 1120 can be stored in any way which is suitable for the computer program product 1110.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for concurrent transmission of channel state information reference signals, CSI-RSs, in different grids-of-beams, wherein each grid-of-beams is composed of a respective set of beams and wherein each of the grids-of-beams belongs to a respective unique TCI state, wherein the method is performed by a network node and wherein the method comprises:
assigning (S102) CSI-RS resources to a time-frequency grid (600a, 600b, 700),
wherein the time-frequency grid (600a, 600b, 700) is divided into frequency resources in frequency domain and into time resources in time domain,
wherein the CSI-RS resource for at least two of the different grids-of-beams are, for one and the same time resource, interleaved with each other over the frequency resources, and
wherein the CSI-RS resource for different beams within each set of beams are, for one and the same frequency resource, interleaved with each other over the time resources; and
performing a beamformed CSI-RS transmission in accordance with the assigned CSI-RS resources.

2. The method according to claim 1, wherein all the CSI-RS resource assigned to a respective set of the different grids-of-beams are contained within a corresponding respective set of frequency resources, and wherein there are at least two different such respective sets of the different grids-of-beams and corresponding respective sets of frequency resources.

3. The method according to claim 2, wherein each set of frequency resources extends in frequency by a multiple of one PRB.

4. The method according to claim 1, wherein all the CSI-RS resource assigned to a respective set of the different beams within each set of beams are contained within a corresponding respective set of time resources, and wherein there are at least two different such respective sets of the different beams within each set of beams and corresponding respective sets of time resources.

5. The method according to claim 4, wherein the time resources are adjacent time resources, and wherein each set of adjacent time resources extends in time by a multiple of one PRB.

6. (canceled)

7. The method according to claim 1, wherein each respective unique TCI state is associated with an SSB.

8. The method according to claim 7, wherein the CSI-RS is concurrently transmitted in at least as many beams as there are TCI states in a service area covered by digital beamforming.

9. The method according to claim 1, wherein each frequency resource corresponds to one subcarrier.

10. The method according to claim 1, wherein each time resource has a time duration of one symbol.

11. The method according to claim 10, wherein, in each symbol, CSI-RSs are transmitted in at least as many beams as there are grid-of-beams.

12. The method according to claim 1, wherein the method further comprises:
configuring all UEs served by the network node and for which the CSI-RSs are shared with identical RRC configuration regarding the CSI-RS resources.

13. The method according to claim 12, wherein the UEs are a-periodically configured for the beamformed CSI-RS transmission, and wherein the beamformed CSI-RS transmission is indicated using a specific trigger state in a downlink control information, DCI, CSI request field.

14. The method according to claim 12, wherein the UEs are semi-persistently configured for the beamformed CSI-RS transmission, and wherein the beamformed CSI-RS transmission is indicated in a medium access control, MAC, control element, CE.

15. The method according to claim 12, wherein the UEs are configured for periodic beamformed CSI-RS transmission.

16. The method according to claim 1, wherein the beamformed CSI-RS transmission is performed as part of a beam management process for UEs (160) served in the sets-of-beams.

17. The method according to claim 1, , wherein the CSI-RS are transmitted using millimeter wave communication.

18. A network node for concurrent transmission of channel state information reference signals, CSI-RSs, in different grids-of-beams, wherein each grid-of-beams is composed of a respective set of beams and wherein each of the grids-of-beams belongs to a respective unique TCI state, the network node comprising processing circuitry the processing circuitry being configured to cause the network node to:
assign CSI-RS resources to a time-frequency grid,
wherein the time-frequency grid is divided into frequency resources in frequency domain and into time resources in time domain,
wherein the CSI-RS resource for at least two of the different grids-of-beams are, for one and the same time resource, interleaved with each other over the frequency resources, and
wherein the CSI-RS resource for different beams within each set of beams are, for one and the same frequency resource, interleaved with each other over the time resources; and
perform a beamformed CSI-RS transmission in accordance with the assigned CSI-RS resources.

19. (canceled)

20. The network node according to claim 18, wherein all the CSI-RS resource assigned to a respective set of the different grids-of-beams are contained within a corresponding respective set of frequency resources, and wherein there are at least two different such respective sets of the different grids-of-beams and corresponding respective sets of frequency resources.

21. A computer program for concurrent transmission of channel state information reference signals, CSI-RSs, in different grids-of-beams, wherein each grid-of-beams is composed of a respective set of beams and wherein each of the grids-of-beams belongs to a respective unique TCI state, the computer program comprising computer code which, when run on processing circuitry of a network node, causes the network node to:
assign CSI-RS resources to a time-frequency grid,
wherein the time-frequency grid is divided into frequency resources in frequency domain and into time resources in time domain,
wherein the CSI-RS resource for at least two of the different grids-of-beams are, for one and the same time resource, interleaved with each other over the frequency resources, and
wherein the CSI-RS resource for different beams within each set of beams are, for one and the same frequency resource, interleaved with each other over the time resources; and
perform a beamformed CSI-RS transmission in accordance with the assigned CSI-RS resources.

22. A computer program product comprising a computer program according to claim 21, and a computer readable storage medium on which the computer program is stored.
